(19) United States
(12) Patent Application Publication
(10) Pub. No.: US 2025/0094051 A1
(43) Pub. Date: Mar. 20, 2025

(54) STORAGE DEVICE AND OPERATING METHOD OF STORAGE DEVICE

(71) Applicant: SAMSUNG ELECTRONICS CO., LTD., Suwon-si (KR)

(72) Inventors: Byeonghui KIM, Suwon-si (KR); Seongho Roh, Suwon-si (KR); Hyeongyu Min, Suwon-si (KR); Jisoo Kim, Suwon-si (KR); Hyunkyo Oh, Suwon-si (KR); Han Kyoo Lee, Suwon-si (KR); Kibeen Jung, Suwon-si (KR)

(73) Assignee: SAMSUNG ELECTRONCS CO., LTD., Sowon-si (KR)

(21) Appl. No.: 18/592,065

(22) Filed: Feb. 29, 2024

(30) Foreign Application Priority Data
Sep. 20, 2023 (KR) 10-2023-0125177

(51) Int. Cl. G06F 3/06

(52) U.S. Cl. CPC G06F 3/061; G06F 3/0659; G06F 3/0683

(57) ABSTRACT

A storage device includes: at least one nonvolatile memory device configured to store or read data; and at least one controller configured to: control the at least one nonvolatile memory device, perform at least one workload of a plurality of workloads, based on at least one parameter, perform a tuning for improvement of a performance and a Quality-of-Service (QOS) conformity with a first storage device associated with the workload, and wherein the at least one controller is further configured to individually perform the tuning for each of the plurality of workloads that are different kinds.

### CROSS-REFERENCE TO RELATED APPLICATION

This application claims priority under 35 U.S.C. § 119 to Korean Patent Application No. 10-2023-0125177 filed on Sep. 20, 2023, in the Korean Intellectual Property Office, the disclosures of which are incorporated by reference herein in their entireties.

### BACKGROUND

### 1. Field

The disclosure relates to a storage device and an operating method of the storage device.

### 2. Description of Related Art

The amount of data is increasing as artificial intelligence (AI) and autonomous driving are commercialized. As such, a storage capacity of a data center is continuously increasing, and services of the data center are also evolving.

As a solid state drive (SSD) provides high I/O performance and low energy consumption compared to a hard disk drive (HDD), the use of the solid state drive is expanding in a data center and cloud computing environment where multiple users share resources.

A storage device that supports a high specification and a high performance is developing. With the development of the storage devices, storage devices with different specifications may be used in the same data center. In particular, the software architecture of the SSD is complex, and many parameters for modules and algorithms performing functions of the SSD exist. In general, the parameters of the SSD are optimized for the maximum performance of a workload that the SSD performs.

### SUMMARY

Provided is a storage device capable of improving performance and QoS conformity between storage devices with different specifications.

According to an aspect of the disclosure, a storage device includes: at least one nonvolatile memory device configured to store or read data; and at least one controller configured to: control the at least one nonvolatile memory device, perform at least one workload of a plurality of workloads, based on at least one parameter, perform a tuning for improvement of a performance and a Quality-of-Service (QOS) conformity with a first storage device associated with the workload, and wherein the at least one controller is further configured to individually perform the tuning for each of the plurality of workloads that are different kinds.

According to an aspect of the disclosure, a storage device includes: at least one nonvolatile memory device; and at least one controller configured to control the at least one nonvolatile memory device and to perform a workload based on at least one parameter, wherein a value of the at least one parameter is set such that: a first similarity between a first performance measured when the storage device performs the workload and a second performance measured when a second storage device performs the workload is maximized, and a second similarity between a quality of service (QOS) index of the storage device and a QoS index of the second storage device is maximized, and wherein, based on the first similarity and the second similarity, the at least one parameter is set individually for each workload of a plurality of workloads.

According to an aspect of the disclosure, an operating method of a storage device, includes: receiving a tuning request from a host device; receiving, from the host device, at least one of a target performance specification and a target QoS specification; receiving a workload from the host device; controlling a nonvolatile memory to perform the workload based on a parameter and changing a value of the parameter; monitoring a performance and a Quality-of-Service (QOS) of the workload for each of the changed value of the parameter; and determining the value of the parameter for the workload based on the performance and the QoS of the workload, wherein the determining of the value of the parameter includes: determining the value of the parameter such that the performance and a QoS conformity with a first storage device associated with the workload is maximized; and individually determining the value of the parameter for each workload of a plurality of workloads that are different kinds.

According to an aspect of the disclosure, an operating method of a storage device, includes: receiving, from a host device, a transmission request for a parameter metadata; in response to the request, sending the parameter metadata to the host device; receiving a request indicating an activation of a parameter table included in the parameter metadata, wherein the parameter table is associated with one of pieces of information of the parameter table; activating the parameter table designated by the host device; detecting a workload assigned by the host device; and based on the detected workload that is associated with the parameter table, performing the detected workload based on the parameter table.

### BRIEF DESCRIPTION OF THE DRAWINGS

The above and other objects and features of the disclosure will become apparent by describing in detail embodiments thereof with reference to the accompanying drawings:

FIG. 1 is a diagram illustrating a storage device according to an embodiment of the disclosure;

FIG. 2 is a diagram illustrating a configuration of a storage device according to the embodiment of FIG. 1;

FIG. 3 is a diagram illustrating a configuration of an auto-tuning engine of a controller according to the embodiment of FIG. 2;

FIG. 4 is a diagram illustrating a target performance and QoS specification table according to an embodiment of the disclosure;

FIG. 5 is a diagram illustrating a parameter table according to an embodiment of the disclosure;

FIG. 6 is a diagram illustrating parameter metadata according to an embodiment of the disclosure;

FIG. 7 is a diagram illustrating a configuration of a memory device of a storage device according to the embodiment of FIG. 2;

FIG. 8 is a diagram illustrating a configuration of an auto-tuning engine according to another embodiment of the disclosure;

FIG. 9 is a diagram describing an operating method of a storage device according to an embodiment of the disclosure;

FIG. 10 is a diagram describing an operating method of a storage device according to another embodiment of the disclosure;

FIG. 11 is a diagram describing an operation in which a storage device sends a parameter table to a host device, according to an embodiment of the disclosure;

FIG. 12 is a diagram describing an operation in which a storage device sends a parameter table to any other storage device, according to an embodiment of the disclosure; and

FIG. 13 is a diagram illustrating an operation in which a storage device performs tuning for performance and QoS conformity based on a learning log provided from a host device, according to an embodiment of the disclosure.

### DETAILED DESCRIPTION

The description merely illustrates the principles of the disclosure. Those skilled in the art will be able to devise one or more arrangements that, although not explicitly described herein, embody the principles of the disclosure. Furthermore, all examples recited herein are principally intended expressly to be only for explanatory purposes to help the reader in understanding the principles of the disclosure and the concepts contributed by the inventor to furthering the art and are to be construed as being without limitation to such specifically recited examples and conditions. Moreover, all statements herein reciting principles, aspects, and embodiments of the disclosure, as well as specific examples thereof, are intended to encompass equivalents thereof.

Terms used in the disclosure are used only to describe a specific embodiment, and may not be intended to limit the scope of another embodiment. A singular expression may include a plural expression unless it is clearly meant differently in the context. The terms used herein, including a technical or scientific term, may have the same meaning as generally understood by a person having ordinary knowledge in the technical field described in the present disclosure. Terms defined in a general dictionary among the terms used in the present disclosure may be interpreted with the same or similar meaning as a contextual meaning of related technology, and unless clearly defined in the present disclosure, it is not interpreted in an ideal or excessively formal meaning. In some cases, even terms defined in the disclosure cannot be interpreted to exclude embodiments of the present disclosure.

In one or more embodiments of the disclosure described below, a hardware approach is described as an example. However, since the one or more embodiments of the disclosure include technology that uses both hardware and software, the various embodiments of the present disclosure do not exclude a software-based approach.

In addition, in the disclosure, in order to determine whether a specific condition is satisfied or fulfilled, an expression of more than or less than may be used, but this is only a description for expressing an example, and does not exclude description of more than or equal to or less than or equal to. A condition described as ‘more than or equal to’ may be replaced with ‘more than’, a condition described as ‘less than or equal to’ may be replaced with ‘less than’, and a condition described as ‘more than or equal to and less than’ may be replaced with ‘more than and less than or equal to’. In addition, hereinafter, ‘A’ to ‘B’ means at least one of elements from A (including A) and to B (including B).

The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. The expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

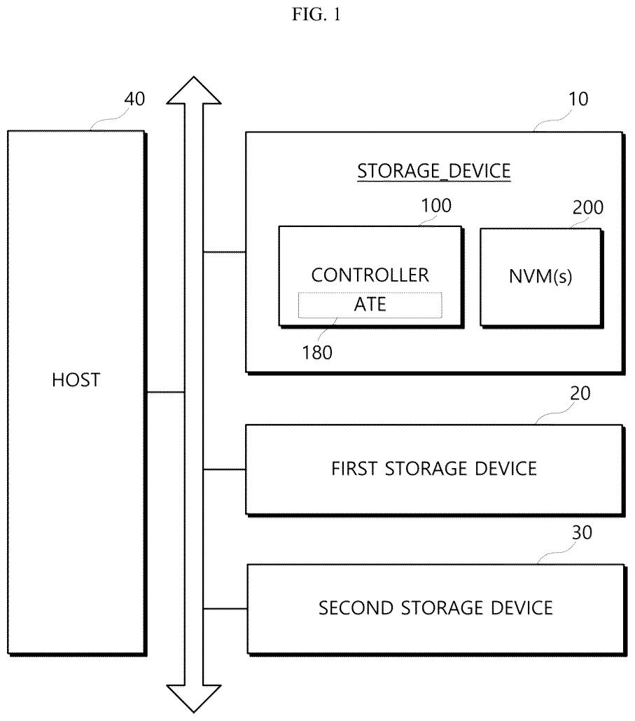

FIG. 1 is a diagram illustrating a storage device 10 according to an embodiment of the disclosure. The storage device 10 according to an embodiment of the disclosure may perform tuning for performance and QoS conformity with at least one of any other storage devices (a first storage device 20 and a second storage device 30).

Referring to FIG. 1, the storage device 10 may be electrically connected to a host device 40 together with the other storage devices (the first storage device 20 and the second storage device 30). Through the disclosure, the storage device 10 may refer to a storage device, which is different from the other storage devices (the first storage device 20 and the second storage device 30).

The host device 40 may include a data center server, a cloud server, a personal computer, a laptop computer, or other electronic devices.

The storage device 10 may function as a nonvolatile storage device that stores data (regardless of whether a power is supplied) and the storage device 10 may have a relatively high storage capacity compared to a memory device of the host device 40.

The storage device 10 may be implemented to be physically independent of the host device 40 or may be implemented in the same package as the host device 40.

The storage device 10 may be coupled to any other components of the host device 40 through a connection interface, so as to communicate with each other.

The storage device 10 may include a controller 100 and at least one nonvolatile memory device (NVM(s)) 200.

The controller 100 may control the nonvolatile memory device 200 to process or perform a workload. The nonvolatile memory device 200 may store (or referred to as a “write” or “program”), erase, and/or read data under control of the controller 100. In the specification, the workload means at least one I/O that the host device 40 assigns to a storage device. Accordingly, the assignment of the workload or the transmission of the workload means assigning at least one I/O or sending at least one I/O. Throughout the disclosure, the controller 100 may refer to at least one controller (processor) (that is, a single controller or two or more controllers).

The nonvolatile memory device 200 may include a flash memory of a two-dimensional (2D) structure or a two-dimensional (3D) structure. The flash memory may include different kinds of nonvolatile memories such as a NAND flash memory, a vertical NAND (V-NAND) flash memory, a NOR flash memory, a magnetic RAM (MRAM), a phase RAM (PRAM), a ferroelectric random access memory (FRAM), a spin transfer torque random access memory (STT-RAM) and/or a resistive RAM (RRAM). In some embodiments, the nonvolatile memory device 200 may include computer codes or instructions.

The specification of the storage device 10 according to an embodiment of the disclosure may be different from the specifications of the other storage devices (the first storage device 20 and the second storage device 30). The hardware or software specification of the storage device 10 may be different from the hardware or software specification(s) of the other storage devices (the first storage device 20 and the second storage device 30). Alternatively, the manufacturer of the storage device 10 may be different from the manufacturer(s) of the other storage devices (the first storage device 20 and the second storage device 30), or even though the manufacturer of the storage device 10 is the same as the manufacturer of the other storage devices (the first storage device 20 and the second storage device 30), the technology applied to the storage device 10 may be different from the technology applied to the other storage devices (the first storage device 20 and the second storage device 30). In this case, before the tuning for performance and QoS conformity, the performance and/or the QoS measured when the storage device 10 performs the same workload may be different from the performance and/or the QoS of the other storage devices (the first storage device 20 and the second storage device 30).

In the specification, the performance and QoS conformity means that the performance and/or the QoS measured when a storage device performs a workload is similarly maintained within a given range. For example, the performance and QoS conformity may mean that a result of measuring the performance and/or the QoS when different storage devices perform the same workload indicates that an Input/Output operations per second (IOPs) is similarly maintained within a preset range. Alternatively, the performance and QoS conformity may mean that a result of measuring the performance when different storage devices perform the same workload indicates that at least one or more performance metrics are similarly maintained within a preset range. Alternatively, the performance and QoS conformity may mean that a result of measuring the QoS when different storage devices perform the same workload indicates that a QoS metric is similarly maintained within a preset range. The QoS metric may include a write QoS, a read QoS, or indexes associated with reliability.

When values of features (such as a read or write ratio, a block size, and a queue depth (QD)) are different, workloads may be distinguished as different workloads. That is, workloads may be distinguished from each other based on characteristics. In addition, according to an embodiment, when workloads have different values with regard to any one feature, the workloads may be distinguished as different workloads. Alternatively, according to an embodiment, when workloads have different values with regard to a plurality of features, the workloads may be distinguished as different workloads. According to an embodiment, a feature of a workload may include an I/O chuck size, an I/O interval, etc. In the specification, the expression that features of workloads are different may mean that a plurality of workloads have different values with regard to at least one feature among a plurality of features.

When the host device 40 requests the storage device 10 to perform a tuning for performance and QoS conformity, the storage device 10 may perform the tuning with at least one of the other storage devices (the first storage device 20 and the second storage device 30). The tuning for performance and QoS conformity may include a feature of changing a value of at least one of a plurality of parameters that are used to perform a workload.

In an embodiment of the tuning for performance and QoS conformity, the storage device 10 may receive a request for the tuning for performance and QoS conformity from the host device 40 and the storage device 10 may operate in a tuning parameter learning mode for searching for optimal parameter values for the performance and QoS conformity.

During the tuning for performance and QoS conformity with the first storage device 20 (i.e., in the tuning parameter learning mode), an auto-tuning engine (ATE) 170 of the controller 100 may change values of parameters necessary to perform a workload. In FIG. 1, the ATE 170 is shown as a part of the controller 100. In some embodiments, the ATE 170 may be located outside of the controller 100.

As the auto-tuning engine 170 controls the nonvolatile memory device 200 for each changed parameter value such that the read or write operation is performed, the workload provided from the host device 40 may be performed. Whenever values of parameters are changed, the auto-tuning engine 170 may store a result of a performance metric and a QoS metric of a workload. The storage device 10 may store parameter values, which are the most similar to the performance metric and/or the QoS metric of the first storage device 20 while satisfying a performance requirement and/or a QoS requirement provided from the host device 40, as optimal parameter values.

When the storage device 10 performs the tuning for performance and QoS conformity with respect to different kinds of workloads, the storage device 10 may independently perform the tuning for each workload. For example, the storage device 10 may perform the parameter learning mode, with respect to a random workload, with the write ratio of 25% and the queue depth QD of 4, which is classified as one of three workloads whose block sizes are 4K, 16K, and 128K, respectively. The storage device 10 may store an optimal parameter value(s) for each of the three workloads in a parameter table so as to be distinguished from each other.

In another embodiment of the tuning for performance and QoS conformity, the storage device 10 may receive a request for the tuning for performance and QoS conformity from the host device 40 and the storage device 10 may operate in a parameter designation mode to search for optimal parameter values for the performance and QoS conformity.

For example, the storage device 10 may receive a request for the performance and QoS conformity from the host device 40. The storage device 10 may activate one of a plurality of parameter tables of parameter metadata stored in the nonvolatile memory device 200. The storage device 10 may change a value of at least one of preset parameters into a value of a parameter stored in one of the plurality of parameter tables. Alternatively, the storage device 10 may load one of the plurality of parameter tables of the parameter metadata to a working memory.

In an embodiment, the storage device 10 may provide the parameter table stored in the nonvolatile memory device 200 to at least one of the other storage devices (the first storage device 20 and the second storage device 30) through the host device 40.

The host device 40 may store the performance requirement and/or the QoS requirement for the performance and QoS conformity for each of the other storage devices (the first storage device 20 and the second storage device 30). When the storage device 10 requires the performance and QoS conformity with the first storage device 20, the host device 40 may send the performance requirement and/or the QoS requirement of the first storage device 20 to the storage device 10. When the storage device 10 requires the performance and QoS conformity with the second storage device 30, the host device 40 may send the performance requirement and/or the QoS requirement of the second storage device 30 to the storage device 10.

In some embodiments, the first storage device 20 and the second storage device 30 may have the same specification. In other embodiments, the first storage device 20 and the second storage device 30 may have different specifications. When the specifications of the first storage device 20 and the second storage device 30 are different from each other, the tuning for performance and QoS conformity of the storage device 10 may be performed based on the specification of one of the first storage device 20 and the second storage device 30. That is, the host device 40 may send the performance requirement and/or the QoS requirement, which is based on the specification of one of the first storage device 20 and the second storage device 30, to the storage device 10.

In an embodiment, the performance requirement and/or the QoS requirement necessary for the performance and QoS conformity may be dynamically sent to the storage device 10. For example, the host device 40 may assign a specific workload to the first storage device 20. Then, the host device 40 may measure a result of the performance metric and/or the QoS metric of the first storage device 20 associated with the specific workload. Alternatively, after the specific workload of the first storage device 20 is performed, the host device 40 may receive a result of the performance metric and/or the QoS metric from the first storage device 20. After the host device 40 assigns the same specific workload to the storage device 10, the host device 40 may send the result of the performance metric and/or the QoS metric, which is measured and received from the first storage device 20, to the storage device 10 as the performance requirement and/or the QoS requirement.

Accordingly, the storage device 10 may dynamically perform the tuning for performance and QoS conformity in response to a change of any other storage device connected to the host device 40.

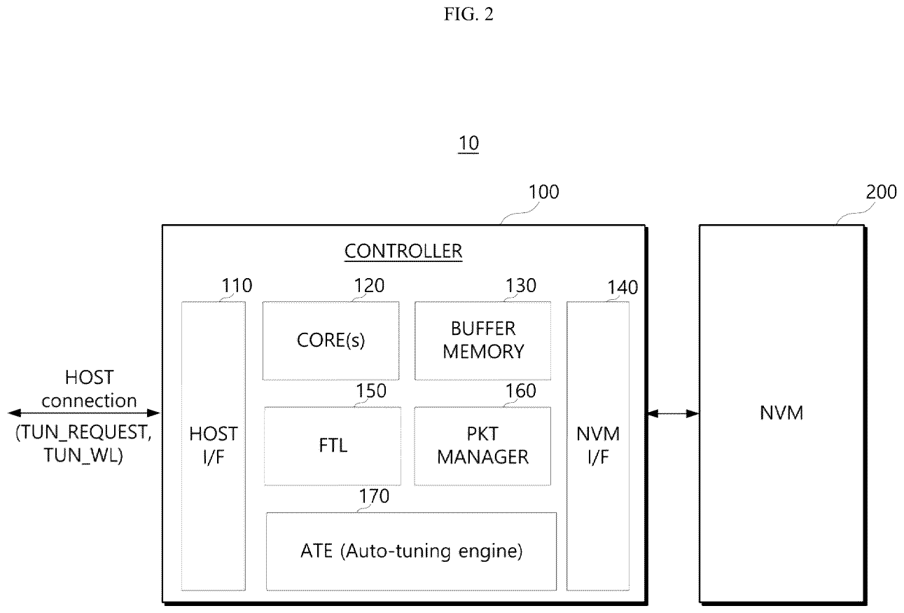

FIG. 2 is a diagram illustrating a configuration of the storage device 10 according to the embodiment of FIG. 1. A configuration of the storage device 10 will be described with reference to FIGS. 1 and 2. Referring to FIG. 2, the storage device 10 may include the controller 100 and the at least one nonvolatile memory device 200.

The controller 100 may include a host interface 110, at least one core 120, a buffer memory 130, a nonvolatile memory interface 140, a flash translation layer (FTL) 150, a packet (PKT) manager 160, and the auto-tuning engine 170. The controller 100 may further include a working memory to which the firmware is loaded.

The controller 100 may exchange packets with the host device 40 through the host interface 110. The controller 100 may receive a workload by using the packet sent through the host interface 110. The packet that the controller 100 receives may include a command of the host device 40 or data to be stored in the nonvolatile memory device 200. The controller 100 may send a result of the workload to the host device 40 through the host interface 110. The packet that the controller 100 sends to the host device 40 through the host interface 110 may include a response to the command or the data read from the nonvolatile memory device 200. In the specification, the expressions “a command of a workload” and “a request of a workload” may be used as the same meaning.

The host interface 110 may be implemented with various interfaces such as an advanced technology attachment (ATA) interface, a serial ATA (SATA) interface, an external SATA (e-SATA) interface, a small computer small interface (SCSI), a serial attached SCSI (SAS), a peripheral component interconnection (PCI) interface, a PCI express (PCIe) interface, an IEEE 1394 interface, a universal serial bus (USB) interface, and a non-volatile host controller express (NVMe) interface. For example, the controller 100 may generate packets complying with the NVMe standard protocol and the controller 100 may exchange the packets with the host device 40.

The core 120 may include or correspond to at least one core (a single core or multiple cores). The core 120 may load the firmware of the storage device 10 to the working memory and the core 120 may perform an overall operation of the controller 100. The core 120 may load the flash translation layer 150 to the working memory and the core 120 may write or read the data in or from the nonvolatile memory device 200 based on the flash translation layer 150.

The buffer memory 130 may temporarily store the data to be written in the nonvolatile memory device 200 or the data read from the nonvolatile memory device 200. According to an embodiment, the buffer memory 130 may be disposed inside or outside the controller 100.

The nonvolatile memory interface 140 may send the data to be written in the nonvolatile memory device 200 to the nonvolatile memory device 200 or may receive the data read from the nonvolatile memory device 200. The nonvolatile memory interface 140 may be implemented to comply with the standard protocol such as Toggle or ‘open NAND flash interface’ (ONFI).

The flash translation layer 150 may perform various operations (functions) such as address mapping, wear-leveling, and garbage collection. The address mapping operation refers to an operation of translating a logical address received from a host into a physical address to be used to actually store the data in the nonvolatile memory device 200. The wear-leveling (that is a technology for allowing blocks of the nonvolatile memory device 200 to be used uniformly such that excessive degradation of a specific block is prevented) may be implemented, for example, through a firmware technology for balancing erase counts of physical blocks. The garbage collection refers to a technology for securing an available capacity of the nonvolatile memory device 200 through a way to copy valid data of a block to a new block and then erase the block.

The packet manager 160 may generate the packet complying with an interface protocol negotiated with the host device 40 or may parse various kinds of information from the packet received from the host device 40.

In addition, in some embodiments, the controller 100 may include an error correction code (ECC) engine that performs an error detection and correction function with respect to the read data read from the nonvolatile memory device 200 and an advanced encryption standard (AES) engine that performs a security operation on the data input to the controller 100.

The controller 100 of the storage device 10 according to an embodiment of the disclosure may receive a request TUN_REQUEST indicating the tuning for performance and QoS conformity and a workload TUN_WL targeted for tuning from the host interface 110 through the host interface 110.

The packet manager 160 may parse the packet received from the host device 40 and the parsed packet is provided to the core 120. The core 120 may determine the request TUN_REQUEST indicating the tuning from the parsed information and the core 120 may direct the auto-tuning engine 170 to perform the tuning for performance and QoS conformity with respect to the workload TUN_WL targeted for tuning.

The auto-tuning engine 170 may perform the tuning for performance and QoS conformity with respect to the workload TUN_WL targeted for tuning in response to the request TUN_REQUEST indicating the tuning. That is, the auto-tuning engine 170 may perform the tuning for performance and QoS conformity individually for each of different kinds of workloads.

For example, returning to FIG. 1, the storage device 10 may perform the tuning for performance and QoS conformity with the first storage device 20 with respect to each of a total of 120 random workloads defined by three block sizes of 4K, 16K, and 128K, eight queue depths QD of 1, 2, 4, 8, 16, 32, 64, and 128, and five write ratios of 0%, 25%, 50%, 75%, and 100%. The storage device 10 may perform the tuning for performance and QoS conformity with the first storage device 20 with respect to 120 workloads such that the specific QoS requirement is satisfied in a state where a difference with the first storage device 20 does not exceed 5% with regard to an IOPs of the performance metric. The storage device 10 may be provided with the performance requirement and/or the QoS requirement from the host device 40. After the tuning for performance and QoS conformity is performed for each workload, changed values of parameters may be classified and stored for each workload. As the workload features for performing the tuning, the above block size, queue depth QD, and write ratio may be provided as an example, and the tuning for performance and QoS conformity may be performed with respect to workloads in which a block size is changed to be smaller or larger and the number of queue depths QD is changed to increase.

To perform the tuning for performance and QoS conformity, the auto-tuning engine 170 may operate in the parameter learning mode or may operate in the parameter designation mode.

In an embodiment, the auto-tuning engine 170 may operate in the parameter learning mode. The auto-tuning engine 170 may determine parameters that are used to perform the workload TUN_WL targeted for tuning. The controller 100 may perform the workload TUN_WL while changing values of at least one of the determined parameters and the controller 100 may monitor the performance of performing the workload TUN_WL. The auto-tuning engine 170 may change the values of the at least one parameter such that the performance of performing the workload TUN_WL is similar to the performance of any other storage device provided from the host device 40. When the performance of performing the workload TUN_WL is similar to the performance of any other storage device provided from the host device 40 within a preset range, when the number of times that a parameter value is changed reaches the given number of times, or when the attempt to change all possible parameter values is made, the auto-tuning engine 170 may stop the tuning. The auto-tuning engine 170 may store values of a parameter, at which the performance of performing the workload TUN_WL targeted for tuning is the most similar to the performing performance and/or the QoS of any other storage device, in one region of the nonvolatile memory device 200 as an optimal parameter table.

In an embodiment, the auto-tuning engine 170 may operate in the parameter designation mode. The auto-tuning engine 170 may send parameter metadata including information about at least one parameter table to the host device 40 through the host interface 110. According to an embodiment, the auto-tuning engine 170 may send, to the host device 40, the parameter metadata including information about parameter tables associated with the workload TUN_WL targeted for tuning. The host device 40 may send information about the selected parameter table to the storage device 10. The auto-tuning engine 170 may store values of parameters stored in the parameter table selected at least by the host device 40 in one region of the nonvolatile memory device 200 as an optimal parameter table. The auto-tuning engine 170 may activate the optimal parameter table. The activation of the optimal parameter table may be made by loading the optimal parameter table to the working memory of the controller 100.

After the auto-tuning engine 170 completes the tuning for performance and QoS conformity, when the core 120 receives a request indicating to perform the same workload as the workload TUN_WL targeted for tuning from the host device 40, the core 120 may search for the optimal parameter table in run-time and the core 120 may use a parameter value of the optimal parameter table to perform the workload.

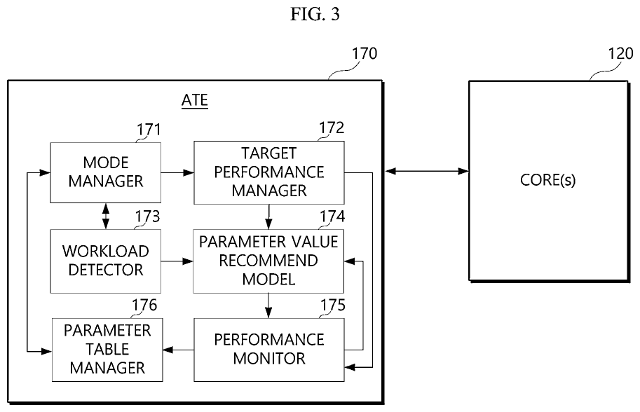

FIG. 3 is a diagram illustrating a configuration of the auto-tuning engine 170 of the controller 100 according to the embodiment of FIG. 2. The auto-tuning engine 170 will be described with reference to FIGS. 2 and 3.

The auto-tuning engine 170 according to an embodiment of the disclosure may perform the tuning for performance and QoS conformity of a workload with respect to a storage device targeted for tuning in a tuning mode. The auto-tuning engine 170 may determine a value of a parameter having the performing performance and/or the QoS similar to the performance, which is measured when the storage device targeted for tuning performs a specific workload, within a given range. The auto-tuning engine 170 may activate an optimal parameter table for the performance and QoS conformity of a workload, which a host device assigns, in run-time.

The auto-tuning engine 170 may include a mode manager 171, a target performance manager 172, a workload detector 173, a parameter value recommend model 174, a performance monitor 175, and a parameter table manager 176. Each component of the auto-tuning engine 170 may be implemented with hardware logic or firmware logic. Alternatively, each component of the auto-tuning engine 170 may be implemented with a combination of hardware logic or firmware logic. Each component of the auto-tuning engine 170 will be described for each function. In some embodiments, a plurality of components are capable of being implemented with one component.

In an embodiment, the mode manager 171 may distinguish and set (a) a tuning mode to perform the tuning for performance and QoS conformity, and (b) a normal mode to perform a workload. The mode manager 171 may set a mode flag indicating the tuning mode or the normal mode in a register. Alternatively, after setting the mode flag indicating the tuning mode or the normal mode, the core 120 may direct the mode manager 171 to perform an operation according to the execution of a specific mode. The following embodiments will be described under the condition that the mode manager 171 sets the mode flag.

In the tuning mode, the mode manager 171 may perform the tuning for performance and QoS conformity with respect to a workload sent together with a tuning command. The ‘tuning mode’ refers to a mode to set an optimal parameter table for the performance and QoS conformity, which is associated with the sent workload. The ‘normal mode’ refers to a mode to apply an optimal parameter table for the performance and QoS conformity, which is associated with the sent workload, to the workload in run-time and perform the workload based on the optimal parameter table thus applied. The normal mode may be performed after the tuning for performance and QoS conformity associated with the workload is performed.

An embodiment of the normal mode will be described.

In an embodiment, the mode manager 171 may provide the received workload to the workload detector 173 and the mode manager 171 may be provided with information of the workload from the workload detector 173. The information of the workload may include information about a feature of the workload, such as a block size, a queue depth, a write ratio, or whether it is a random workload.

In an embodiment, the mode manager 171 may provide the information of the workload to the parameter table manager 176 and the mode manager 171 may be provided with an optimal parameter table suitable for the workload information from the parameter table manager 176. The mode manager 171 may provide the received optimal parameter table to the core 120. Alternatively, the mode manager 171 may change a value of a relevant parameter into a value of at least one of parameters included in the optimal parameter table thus provided. That is, the mode manager 171 may activate the optimal parameter table thus provided. The core 120 may perform the workload based on the value of the parameters included in the optimal parameter table.

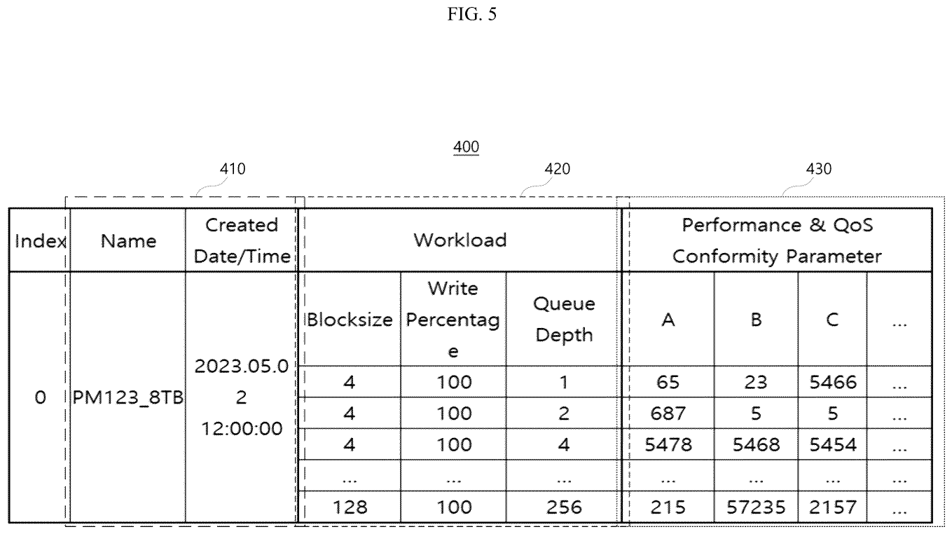

For example, the mode manager 171 may be provided with a parameter table 400 to be described with reference to FIG. 5 from the parameter table manager 176.

In another embodiment of the normal mode, the mode manager 171 may provide the information of the workload to the core 120, and the core 120 may search a parameter table loaded to (or activated on) the working memory for the information of the workload. The core 120 may perform the workload based on a value of a parameter matched with the information of the workload as a found result.

An embodiment of the tuning mode will be described. In an embodiment, when a current mode is the tuning mode, the mode manager 171 may differently operate in the parameter designation mode or the parameter learning mode. The mode manager 171 may set the mode flag so as to correspond to one of the parameter designation mode or the parameter learning mode.

The parameter designation mode refers to a mode to perform the tuning for performance and QoS conformity with any other storage device by searching for a parameter table present in the storage device 10 and setting a value of the parameter table to a value of a parameter for performing the workload.

The parameter learning mode refers to a mode to perform the tuning for performance and QoS conformity with any other storage device by performing comparison with the performance and/or the QoS of the workload of the other storage device while changing a parameter value and setting a parameter value to a parameter value with the performance and/or the QoS of the workload being the most similar. According to an embodiment, information about the performance and/or the QoS of the workload of the other storage device may be provided from the host device 40.

An embodiment of the parameter designation mode will be described.

In an embodiment, the mode manager 171 may request the parameter metadata from the parameter table manager 176. The mode manager 171 may send the parameter metadata provided from the parameter table manager 176 to the core 120, and the core 120 may send the parameter metadata to the host device 40. The core 120 may be provided with information of a parameter table, which the host device 40 selects, from the host device 40. The core 120 may send information about a parameter table, which the host device 40 selects, from among at least one parameter table included in the parameter metadata to the mode manager 171. The mode manager 171 may ask the parameter table manager 176 about the selected parameter table and the mode manager 171 may change a value of parameter into a value of at least one of parameters included in the selected parameter table. Alternatively, the mode manager 171 may ask the parameter table manager 176 about the selected parameter table and the mode manager 171 may determine the selected parameter table as an optimal parameter table. The determination of the selected parameter table as the optimal parameter table may correspond to the loading of the selected parameter table to the working memory of the controller 100.

An embodiment of the parameter learning mode will be described.

In an embodiment, the mode manager 171 may send information about a target performance and QoS requirement, which the host device 40 provides, to the target performance manager 172. The target performance and QoS requirement may be called a target performance and QoS specification. The following embodiment is referred to as a “target performance and QoS specification”. The mode manager 171 may send the workload information provided from the workload detector 173 to the target performance manager 172. The information of the workload may include information about a feature of a workload, such as a block size, a queue depth, a write ratio, or whether it is a random workload.

The target performance manager 172 may map the target performance and QoS specification, which the host device 40 provides, to the workload information so as to be stored as a target performance and QoS specification table. The target performance and QoS specification table may be stored in one region of the nonvolatile memory device 200.

According to an embodiment, the target performance manager 172 may provide the target performance and QoS specification to the parameter value recommend model 174.

The mode manager 171 may provide the received workload to the workload detector 173, and the workload detector 173 may provide the information of the workload to the parameter value recommend model 174.

The parameter value recommend model 174 may determine a value of at least one parameter among parameters and the parameter value recommend model 174 may provide the values of the parameter, thus, determined to the performance monitor 175. The performance monitor 175 may perform the workload provided from the host device 40 based on the determined parameter values. The performance monitor 175 may map a result of performing the workload to a value of a parameter so as to be stored as a learning log. According to an embodiment, the learning log may be sent to the host device 40 in response to a request of the host device 40.

The performance monitor 175 may compare the result of performing the workload with the target performance and QoS specification. The performance monitor 175 may provide a comparison result to the parameter value recommend model 174. When a result of comparing the result of performing the workload with the target performance and QoS specification indicates that a workload performance difference has the performance and QoS conformity of a preset range, the performance monitor 175 may request the parameter value recommend model 174 to stop the change of a value of a parameter. Alternatively, when the number of times of the change of the parameter value reaches the given number of times or when the attempt to change all possible parameter values is made by the parameter value recommend model 174, the performance monitor 175 may request to stop the change of the value of the parameter.

The parameter value recommend model 174 is a model that recommends an optimal parameter value such that the performance and/or the QoS measured when the workload assigned by the host device 40 is performed is similar to the target performance and QoS specification. The parameter value recommend model 174 may determine a value of a parameter based on a search method such as a grid search method, a random search method, or a binary search method or may determine a value of a parameter based on machine learning such as Bayesian optimization or a genetic algorithm. Alternatively, the parameter value recommend model 174 may determine a value of a parameter based on neural network-based machine learning.

For example, in the case of the search method, the performance and/or the QoS measured when the workload is performed in a state where initial values are applied within a range of values of a plurality of parameters may be compared with the target performance and QoS specification. The parameter value recommend model 174 may perform the same process after changing a value of at least one parameter based on a comparison result by using the search algorithm of the search method.

When a value of a parameter is determined based on the machine learning, a machine learning model that is trained based on training data obtained by labeling values of a feature and a parameter of the workload as an input and the measured performing performance and/or the measured QoS of the workload as an output. That is, the machine learning model may be trained by using training data where the values of the feature and the parameter of the workload are used as input data “X” and the measured performing performance and/or the measured QoS of the workload is used as output data “Y”. The machine learning model may be trained by changing a weight parameter of the machine learning model such that a loss between the performing performance and/or the QoS of the workload and the prediction performance and/or the prediction QoS decreases. The machine learning model may be trained by a separate device. Then, the machine learning model may be embedded in the parameter value recommend model 174. Alternatively, the machine learning model may be trained in the storage device 10 before the tuning for performance and QoS conformity.

A value of at least one parameter that maximize the prediction performing performance being the output data “Y” of the machine learning model while changing the value of the at least on parameter in a state where a feature of a workload among the input data “X” is fixed in the trained machine learning model may be selected.

The performance monitor 175 may perform the workload provided from the host device 40 based on the values of the parameter, thus, selected and the performance monitor 175 may map a result of performing the workload based on a value of a parameter so as to be stored as a learning log. The performing result may include the performing performance and/or the QoS of the workload and the similarity of the performing performance and/or the QoS of the workload with the target performance and QoS specification.

When a result of comparing the result of performing the workload with the target performance and QoS specification indicates that a workload performance difference has the performance and QoS conformity of a preset range, the performance monitor 175 may send the feature of the workload and the determined parameter value to the parameter table manager 176.

The parameter table manager 176 may map the determined parameter value to the feature of the workload so as to be stored as a parameter table. The parameter table manager 176 may notify the generation of the parameter table of the mode manager 171, and the mode manager 171 may change a value of at least on parameter into a value of at least one parameter included in the generated parameter table. Alternatively, the mode manager 171 may determine the generated parameter table as the optimal parameter table. The determination of the generated parameter table as the optimal parameter table may correspond to the loading of the parameter table to the working memory of the controller 100.

In an embodiment, the parameter table manager 176 may store information of at least one parameter table as parameter metadata. For example, when the storage device 10 performs the tuning for performance and QoS conformity for each of a plurality of different storage devices, the storage device 10 may store each tuning result as a parameter table. The storage device 10 may store information about the parameter tables as parameter metadata. Alternatively, the parameter table manager 176 may be provided with a parameter table from the host device 40, as well as the parameter table generated in the storage device 10. In this case, the parameter table manager 176 may generate meta information about the parameter table provided from the host device 40. The parameter table manager 176 may record the generated meta information at the previously stored parameter metadata. The parameter table manager 176 may map and store the updated parameter metadata to the provided parameter table.

Another embodiment of the parameter learning mode will be described. The description that is the same as or similar to the description given with reference to the parameter learning mode will be omitted to avoid redundancy.

The parameter value recommend model 174 according to an embodiment of the disclosure may determine a value of at least one parameter based on the learning log sent from the host device 40. The learning log may be a learning log generated while performing the tuning with a storage device targeted for the tuning for performance and QoS conformity in any other storage device.

The learning log may include a value of at least on parameter for performing the workload and the degree of the performance and QoS conformity with the storage device targeted for tuning. The learning log may include the change in the degree of the performance and QoS conformity with the storage device targeted for tuning when a value of at least one parameter are changed. The learning log may include a plurality of learning log information. The learning log information may include mapping information of a specific value of a parameter and the degree of the performance and QoS conformity with the storage device targeted for tuning. The degree of the performance and QoS conformity may mean the similarity between the performance and/or the QoS measured when any other storage device performs a workload and the performance and/or the QoS measured when a storage device targeted for tuning performs a workload.

The parameter value recommend model 174 may determine an optimal parameter value based on the search method or the machine learning method by using a value of at least one parameter of learning log information having the degree of preset performance and QoS conformity from among a plurality of learning log information as a seed.

For example, the search method may be performed after the value of the parameter included in the learning log information is set as an initial parameter value of the grid search method, the random search method, or the binary search method. Alternatively, there may be selected a value of at least one parameter that maximize the prediction performing performance being the output data “Y” of the machine learning model after fixing a feature of a workload among the input data “X” in the trained machine learning model and setting a value of a parameter to the value of the parameter included in the learning log information.

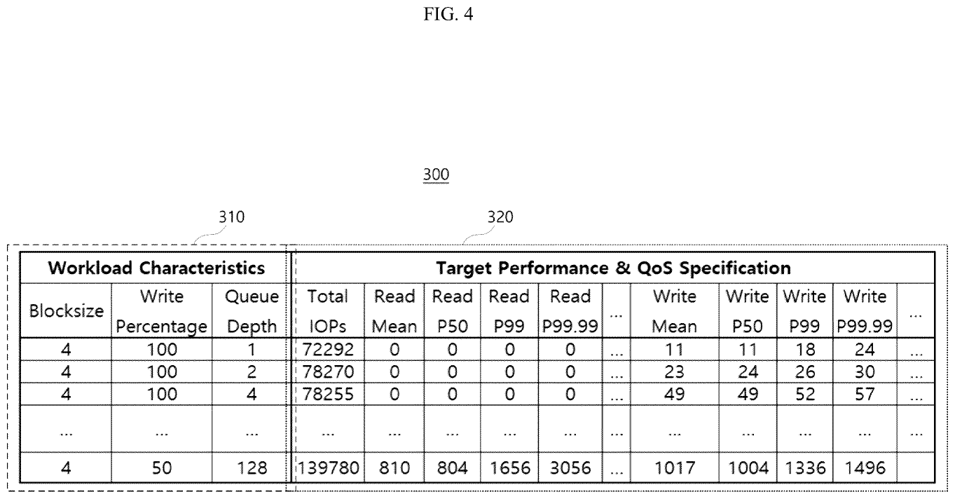

FIG. 4 is a diagram illustrating a target performance and QoS specification table 300. The target performance and QoS specification table 300 will be described with reference to FIGS. 3 and 4.

The target performance manager 172 may map a target performance and QoS specification 320 to workload information 310 provided from the mode manager 171 so as to be stored as the target performance and QoS specification table 300.

The workload information 310 may include information about a feature of a workload, such as a block size, a queue depth, a write ratio, or whether it is a random workload. In the workload feature information included in the workload information 310, the queue depth QD may have a value between 1 and 256, the block size may have a value of 4K, 16K, or 128K, and the write ratio may have a value between 0% and 100%. The values may be provided as examples and embodiments of the disclosure are not limited to the above example values.

The target performance and QoS specification 320 may include a throughput, a write QoS, a read QoS, or indexes associated with reliability. The write QoS and the read Qos may include a write latency percentile and a read latency percentile. The latency percentile may be 99% latency percentile, 99.99% latency percentile, etc. For example, the write latency P99 (Write P99) of the target performance and QoS specification 320 means the degree of a delay of an I/O corresponding to 99% in the case of listing response speeds of a plurality of I/Os in ascending order from smallest to greatest delays (fastest to slowest delays) when a relevant workload is performed.

FIG. 5 is a diagram illustrating the parameter table 400. The parameter table 400 will be described with reference to FIGS. 3 and 5.

The parameter table manager 176 according to an embodiment of the disclosure may map values 430 of a performance and QoS conformity parameter being a result of performing the tuning for performance and QoS conformity with any other storage device to workload information 420 provided from the mode manager 171 so as to be stored as the parameter table 400. According to an embodiment, the parameter table manager 176 may together record environment information 410 where the tuning for performance and QoS conformity is performed, at the parameter table.

The environment information 410 may include a model name of a target storage device where the tuning for performance and QoS conformity is performed, a performance of the target storage device, and a date/time when the tuning for performance and QoS conformity is performed. In addition, the environment information 410 may include a variety of information such as a storage capacity and a manufacturer of the target storage device where the tuning for performance and QoS conformity is performed.

The workload information 420 may include information about a feature of a workload, such as a block size, a queue depth, a write ratio, or whether it is a random workload.

The performance and QoS conformity parameter may include a clock frequency, a completion queue delay, a host-to-device direct memory access (DMA) delay, a device to host delay, an inter-process communication (IPC) delay, etc. The completion queue delay indicates the degree of a delay of a complete response that the storage device 10 sends to the host device 40 after completely processing an I/O received from the host device 40. The host-to-device DMA delay indicates the degree of a delay of transmission from the host device 40 to the storage device 10, and the device to host delay indicates the degree of a delay of transmission from the storage device 10 to the host device 40. The IPC delay indicates the degree of a delay of command transmission between layers. In addition, a delay of transmission between commands in the storage device 10, a delay of data transmission between the storage device 10 and the host device 40, a clock frequency used for operations of internal components of the storage device 10, etc. may be used as the performance and QoS conformity parameter.

The parameter table manager 176 may assign an index to the parameter table 400. The index may be unique information used to distinguish different parameter tables. For example, the index may be an index number that is differently expressed for each parameter table.

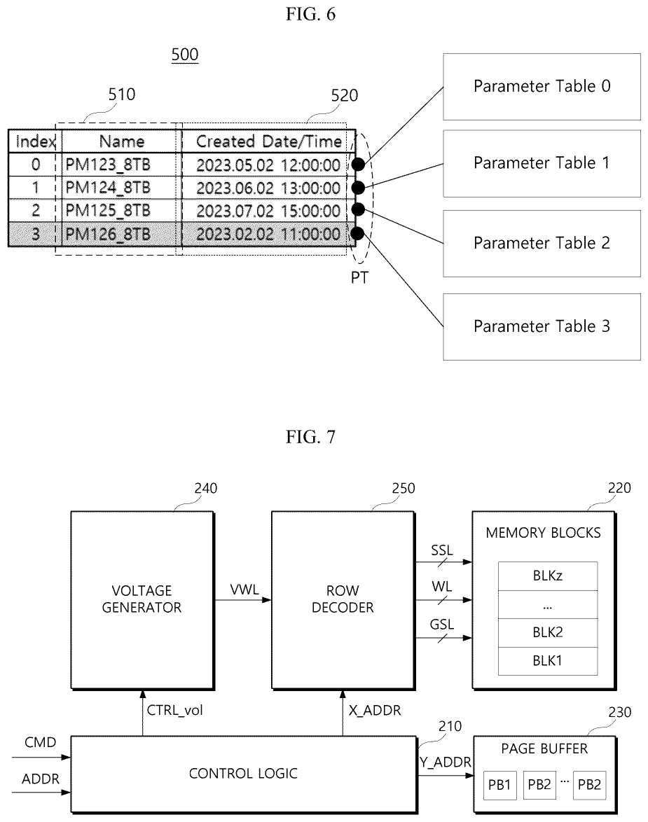

FIG. 6 is a diagram illustrating parameter metadata 500. The parameter metadata 500 will be described with reference to FIGS. 2, 3, and 6.

The parameter table manager 176 according to an embodiment of the disclosure may generate meta information of a parameter table after the tuning for performance and QoS conformity is completed. The parameter table manager 176 may store meta information of at least one parameter table as parameter metadata. The meta information of the parameter table recorded at the parameter metadata 500 may include environment information. The environment information may include a model name of a target storage device 510 where the tuning for performance and QoS conformity is performed, a storage capacity of the target storage device 510, and a date/time 520 when the tuning for performance and QoS conformity is performed. In addition, the environment information may include a variety of information described with reference to FIG. 5. Also, the parameter metadata 500 may include an index number of each meta information. The index number of the meta information may be the same as the index number of the parameter table described with reference to FIG. 5.

In an embodiment, the parameter metadata 500 may include a pointing address PT pointing out a location where a parameter table where each meta information is associated is stored. The pointing address PT may be a physical address or a logical address.

The parameter table manager 176 may update the parameter metadata 500 whenever a parameter table is generated. For example, referring to FIG. 6, after recording meta information of parameter tables Parameter Table 0 to Parameter Table 3 generated in the process of performing the tuning for performance and QoS conformity with respect to PM123_8 TB, PM124_8 TB, and PM125_8 TB, the tuning for performance and QoS conformity may be performed with respect to PM123_8 TB, and a parameter table of PM123_8 TB may be generated. Alternatively, the parameter table of PM123_8 TB may be provided from the host device 40. The parameter table manager 176 may generate meta information including a model name of a target storage device and a data/time when a parameter table is generated, based on the PM123_8 TB parameter table thus provided. The parameter table manager 176 may additionally record the meta information at the parameter meta table together with the pointing address PT where the PM123_8 TB parameter table is stored and an index number of the parameter table.

The controller 100 according to another embodiment of the disclosure may receive a transmission request for parameter metadata from the host device 40.

The auto-tuning engine 170 may send the parameter metadata to the core 120 in response to the transmission request for parameter metadata from the core 120.

The host device 40 may be provided with the parameter metadata from the core 120 of the controller 100. The host device 40 may search the parameter metadata and the host device 40 may request the controller 100 to send one parameter table included in the parameter metadata. For example, the host device 40 may send an index number of the selected parameter table to the controller 100 together with a command for requesting transmission.

The core 120 of the controller 100 may send the index number of the parameter table, which the host device 40 requests, to the auto-tuning engine 170. The auto-tuning engine 170 may read the parameter table from the parameter metadata with reference to a pointing address corresponding to the index number and the auto-tuning engine 170 may send the read parameter table to the host device 40 through the core 120.

The host device 40 may send the received parameter table to any other storage device and the host device 40 may request the other storage device to activate the parameter table thus sent. The other storage device (e.g., the first storage device 20 and the second storage device 30) may activate the received parameter table and the other storage device may perform a workload based on the activated parameter table.

FIG. 7 is a diagram illustrating a configuration of the nonvolatile memory device 200 of the storage device 10 according to the embodiment of FIG. 2. The nonvolatile memory device 200 will be described with reference to FIGS. 2, 6, and 7.

The nonvolatile memory device 200 may include a control logic circuit 210, memory blocks 220, a page buffer 230, a voltage generator 240, and a row decoder 250. In some embodiments, the nonvolatile memory device 200 may include components of a memory device of a well-known solid state drive, such as a memory interface circuit, column logic, a pre-decoder, a temperature sensor, a command decoder, and an address decoder.

The control logic circuit 210 may overall control various kinds of operations of the nonvolatile memory device 200. The control logic circuit 210 may output various kinds of control signals in response to a command CMD and/or an address ADDR from the memory interface circuit. For example, the control signals may include a voltage control signal CTRL_vol, a row address X_ADDR, and a column address Y_ADDR.

The command CMD according to an embodiment of the disclosure may include parameter metadata stored in one region of the memory block 220 and/or a command for reading a parameter table. Alternatively, the command CMD may include parameter metadata stored in one region of the memory block 220 and/or a command for updating or storing a parameter table. The controller 100 may send parameter metadata and/or a command for reading, updating, or storing a parameter table to the nonvolatile memory device 200 together with the pointing address PT (refer to FIG. 6) pointing out an address where the parameter table is stored.

The memory blocks 220 may include a plurality of memory blocks BLK1 to BLKz (z being a positive integer), and each of the plurality of memory blocks BLK1 to BLKz may include a plurality of memory cells. The memory blocks 220 may be connected to the page buffer 230 through bit lines and the memory blocks 220 may be connected to the row decoder 250 through word lines, string selection lines, and ground selection lines.

The page buffer 230 may include a plurality of page buffers PB1 to PBn (n being an integer of 3 or more), and the plurality of page buffers PB1 to PBn may be respectively connected to memory cells through the bit lines. The page buffer 230 may select at least one bit line among the bit lines in response to the column address Y_ADDR. The page buffer 230 may operate as a write driver or a sense amplifiers depending on an operation mode. For example, in the programming (or write) operation, the page buffer 230 may apply a bit line voltage corresponding to data to be programmed to a selected bit line. In the read operation, the page buffer 230 may sense a current or a voltage of the selected bit line to read data stored in a memory cell.

The voltage generator 240 may generate various kinds of voltages for performing the programming, read, and erase operations based on the voltage control signal CTRL_vol.

In response to the row address X_ADDR, the row decoder 250 may select one of the plurality of word lines and the row decoder 250 may select one of the plurality of string selection lines.

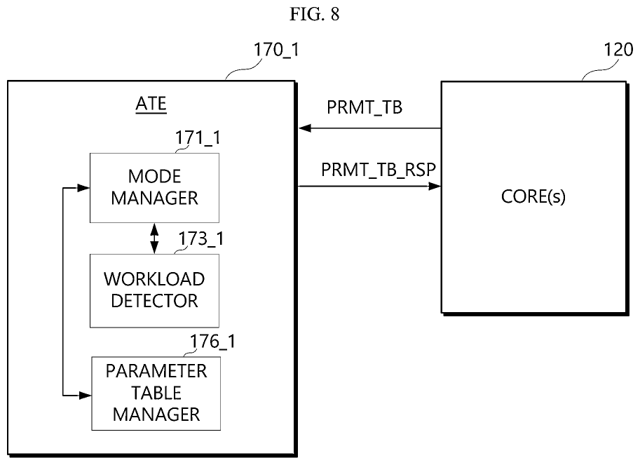

FIG. 8 is a diagram illustrating a configuration of an auto-tuning engine 170_1 according to another embodiment configuration of the disclosure.

The auto-tuning engine 170_1 according to an embodiment of the disclosure may perform the tuning for performance and QoS conformity of a workload with respect to a storage device targeted for tuning in the tuning mode. The auto-tuning engine 170_1 may activate an optimal parameter table for the performance and QoS conformity of a workload, which a host device assigns, in run-time.

The auto-tuning engine 170_1 may receive a first parameter table PRMT_TB from the core 120 in the tuning mode. The first parameter table PRMT_TB may be provided to the host device.

A mode manager 171_1 may provide the received workload to a workload detector 173_1 and the mode manager 171_1 may be provided with information of the workload from the workload detector 173_1. The workload information may include values of features of the workload.

The mode manager 171_1 may send the workload information and the first parameter table PRMT_TB to a parameter table manager 176_1.

The parameter table manager 176_1 may map a value of at least one parameter included in the first parameter table PRMT_TB to values of features of the workload so as to be stored as an optimal parameter table.

Alternatively, the parameter table manager 176 may change a value of at least one parameter among parameters included in the optimal parameter table into a value of at least one parameter included in the first parameter table PRMT_TB.

The parameter table manager 176_1 or the mode manager 171_1 may activate the optimal parameter table based on the first parameter table PRMT_TB.

The parameter table manager 176_1 or the mode manager 171_1 may send a result of setting the optimal parameter table based on the first parameter table PRMT_TB to the core 120 as a response PRMT_TB_RSP.

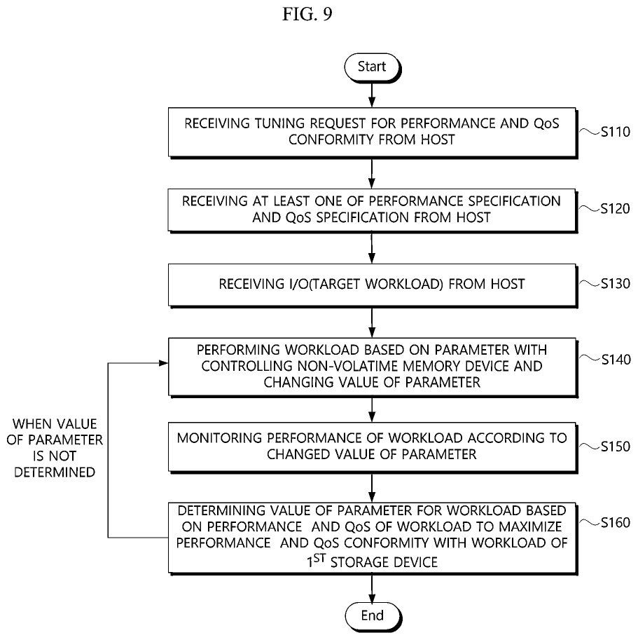

FIG. 9 is a diagram describing an operating method of a storage device according to an embodiment of the disclosure. A storage device according to the embodiment of FIG. 9 may be one of the embodiments of the storage device described with reference to FIGS. 1 to 8.

In operation S110, the storage device may receive a request indicating the tuning for performance and QoS conformity with any other storage device from a host device. The storage device may send a response signal to the request to the host device.

In operation S120, the storage device may receive at least one of a target performance specification and a target QoS specification from the host device. The target performance specification and the target QoS specification may be similar to those of the target performance and QoS specification table described with reference to FIG. 4.

In operation S130, the storage device may receive at least one I/O from the host device. The storage device may parse I/Os to detect a specific workload.

In operation S140, the storage device may control a nonvolatile memory, change a value of a parameter in the storage device, which is a basis of performing a workload, and perform the workload based on the parameter. The parameter value may be changed based on the search method or machine learning.

In operation S150, the storage device may measure the performance and/or the QoS of the workload based on the changed value of the parameter. The performance may be measured based on at least one or more performance metrics such as a read average speed and a write average speed. The QoS may be measured based on a write QoS, a read QoS, or indexes associated with reliability.

In operation S160, the storage device may determine a value of a parameter of the specific workload based on the performance and/or the QoS measured when the workload is performed based on the changed parameter value and the target performance and QoS specification table. The storage device may determine the value of the parameter such that the performance and QoS conformity with any other storage device is maximized. Accordingly, when the degree of conformity between the performance and/or the QoS measured when the workload is performed based on the changed parameter value and the performance and/or the QoS of the target performance and QoS specification table fail to satisfy a present range, the storage device may move to operation S140, and again, change the value of the parameter.

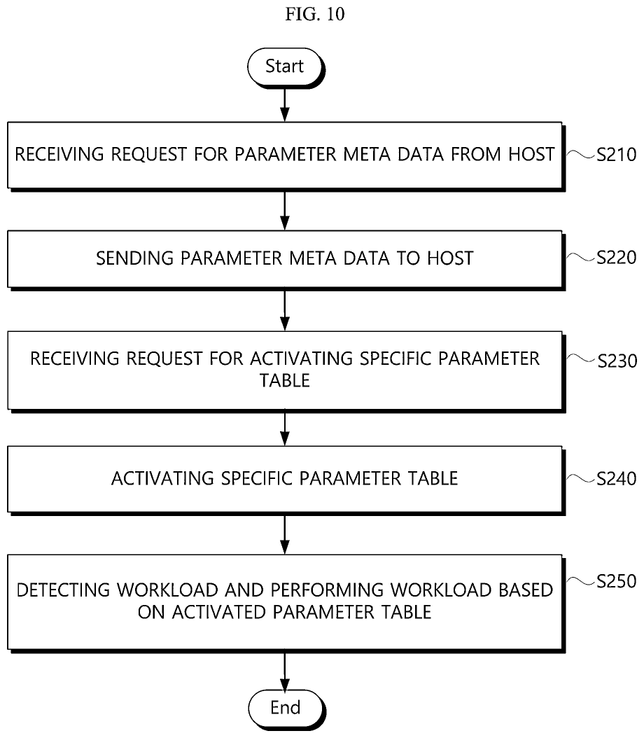

FIG. 10 is a diagram illustrating an operating method in which a storage device performs the tuning for performance and QoS conformity with any other storage device, according to another embodiment of the disclosure. A storage device according to the embodiment of FIG. 10 may be one of the embodiments of the storage device described with reference to FIGS. 1 to 8.

In operation S210, the storage device may receive a transmission request for parameter metadata from a host device.

In operation S220, the storage device may send the parameter metadata to the host device in response to the transmission request for parameter metadata. The parameter metadata may be similar to the parameter metadata described with reference to FIG. 6.

In operation S230, the storage device may receive, from the host device, a request indicating the activation of a parameter table associated with one of pieces of information of a parameter table included in the parameter metadata. For example, the storage device may receive, from the host device, an activation command and one of the plurality of index numbers included in the parameter metadata of FIG. 6.

In operation S240, the storage device may activate the parameter table that the host device designates. The storage device may load the designated parameter table to the working memory.

In operation S250, the storage device may detect a workload that the host device assigns. When the detected workload is a workload associated with the designated parameter table, the storage device may perform the detected workload based on the designated parameter table.

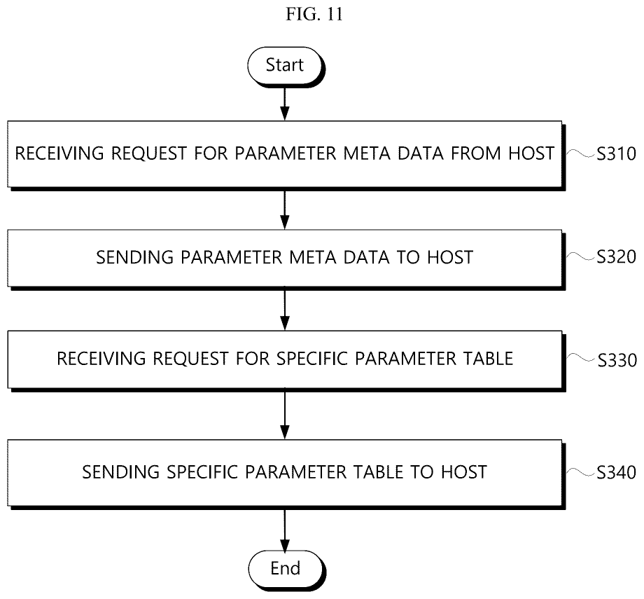

FIG. 11 is a diagram describing an operation in which a storage device sends a parameter table to a host device, according to an embodiment of the disclosure. A storage device according to the embodiment of FIG. 11 may be one of the embodiments of the storage device described with reference to FIGS. 1 to 8.

In operation S310, the storage device may receive a transmission request for parameter metadata from a host device.

In operation S320, the storage device may send the parameter metadata to the host device in response to the transmission request for parameter metadata. The parameter metadata may be similar to the parameter metadata described with reference to FIG. 6.

In operation S330, the storage device may receive, from the host device, a transmission request for a parameter table included in the parameter metadata, and the parameter table may be associated with one of pieces of information of the parameter table. For example, the storage device may receive, from the host device, a transmission command and one of the plurality of index numbers included in the parameter metadata of FIG. 6.

In operation S340, based on a pointing address of the parameter metadata, the storage device may read the requested parameter metadata table from a nonvolatile memory device and the storage device may send the parameter metadata table to the host device.

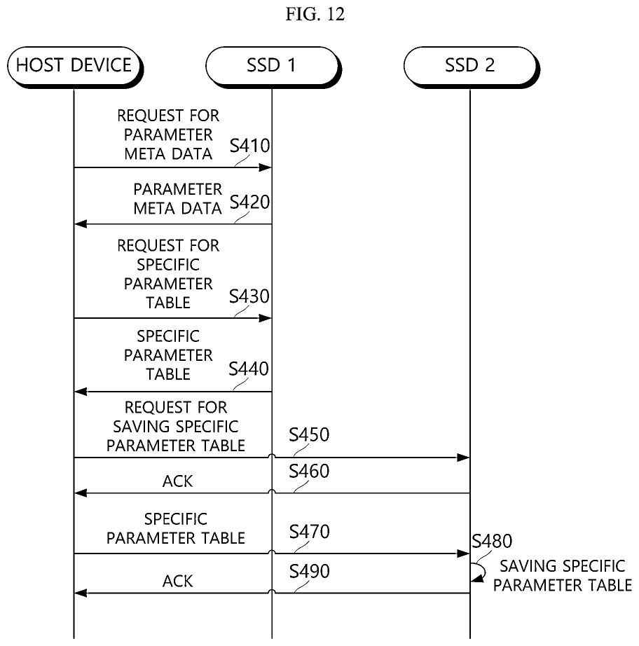

FIG. 12 is a diagram describing an operation in which a storage device sends a parameter table to any other storage device, according to an embodiment of the disclosure. At least one of storage devices SSD1 and SSD2 according to the embodiment of FIG. 12 may be one of the embodiments of the storage device described with reference to FIGS. 1 to 8.

In operation S410, the first storage device SSD1 may receive a transmission request for parameter metadata from a host device.

In operation S420, the first storage device SSD1 may receive the parameter metadata to the host device in response to the request of the host device. The parameter metadata may be similar to the parameter metadata described with reference to FIG. 6.

In operation S430, the first storage device SSD1 may receive, from the host device, a transmission request for a parameter table included in the parameter metadata, and the parameter table may be associated with one of pieces of information of the parameter table.

In operation S440, based on a pointing address of the parameter metadata, the first storage device SSD1 may read the requested parameter metadata table from a nonvolatile memory device and the first storage device SSD1 may send the parameter metadata table to the host device.

In operation S450, the second storage device SSD2 may receive a saving request for the parameter metadata table.

As a response of the second storage device SSD2 sent in operation S460, in operation S470, the second storage device SSD2 may receive the parameter metal table.

In operation S480, the second storage device SSD2 may store the received parameter meta table in the nonvolatile memory device and the second storage device SSD2 may update the parameter meta table so as to be changed to information of the received parameter meta table.

In operation S490, the second storage device SSD2 may send a response to the saving request for the parameter meta table to the host device.

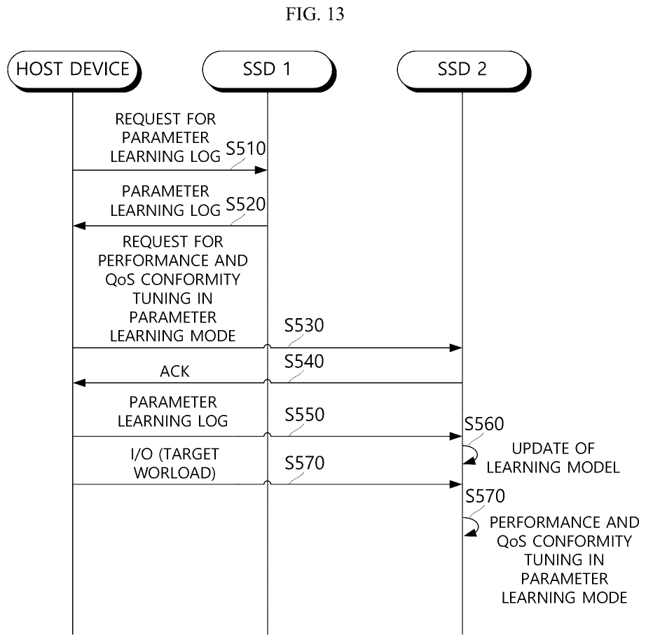

FIG. 13 is a diagram illustrating an operation in which a storage device performs the tuning for performance and QoS conformity based on a learning log provided from a host device, according to an embodiment of the disclosure. At least one of the storage devices SSD1 and SSD2 according to the embodiment of FIG. 13 may be one of the embodiments of the storage device described with reference to FIGS. 1 to 8.

In operation S510, the first storage device SSD1 may receive a transmission request for a parameter learning log from a host device.

In operation S520, the first storage device SSD1 may send the parameter learning log to the host device in response to the request of the host device.

In operation S530, the second storage device SSD2 may receive a request indicating to perform the tuning for performance and QoS conformity in the parameter learning mode.

Based on a response of the second storage device SSD2 sent in operation S540, in operation S550, the second storage device SSD2 may receive the parameter learning log from the host device.

In operation S560, the second storage device SSD2 may update a parameter change method of the parameter learning mode. For example, the second storage device SSD2 may set a value of at least one parameter of learning log information as a seed of the search method or the machine learning method.

In operation S570, the second storage device SSD2 may receive a workload targeted for tuning from the host device and the second storage device SSD2 may perform the tuning for performance and QoS conformity in the parameter learning mode.

A storage device according to the disclosure may tune parameters such that a performance measured when a second storage device whose specification is different from that of the storage device performs a workload is similarly maintained. Accordingly, the storage device according to the disclosure may improve the performance and QoS conformity with the second storage device whose specification is different from that of the storage device.

While the disclosure has been described with reference to embodiments thereof, it will be apparent to those of ordinary skill in the art that various changes and modifications may be made thereto without departing from the spirit and scope of the disclosure as set forth in the following claims.

What is claimed is:

1. A storage device comprising:
at least one nonvolatile memory device configured to store or read data; and
at least one controller configured to:
control the at least one nonvolatile memory device,
perform at least one workload of a plurality of workloads, based on at least one parameter,
perform a tuning for improvement of a performance and a Quality-of-Service (QoS) conformity with a first storage device associated with the workload, and
wherein the at least one controller is further configured to individually perform the tuning for each of the plurality of workloads that are different kinds.

2. The storage device of claim 1, wherein the at least one controller is further configured to:
perform a machine learning-based tuning about the at least one parameter for the each of the plurality of workloads that are the different kinds, and
perform the tuning until a first difference between the performance measured in a first process of performing the at least one workload and a target performance reaches a first preset range or until a second difference between a QoS measured in a second process of performing the at least one workload and a target QoS reaches a second preset range.

3. The storage device of claim 1, wherein the at least one controller is further configured to:
receive, from a host device, a learning log generated through the tuning performed in a second storage device based on machine learning; and
perform the machine learning-based tuning by using the learning log for the improvement of the performance and the QoS conformity with the first storage device.

4. The storage device of claim 3, wherein the at least one controller is further configured to:
determine a parameter value to be used in the tuning based on performance information, QoS information, and
determine a value of the at least one parameter included in the learning log.

5. The storage device of claim 2, wherein the target performance is set based on a second performance measured when the first storage device performs the at least one workload.

6. The storage device of claim 1, wherein the at least one controller is further configured to:
receive, from a host device, a first parameter table for the performance and the QoS conformity with the first storage device;
perform the tuning by changing a value of the at least one parameter based on the first parameter table.

7. The storage device of claim 1, wherein the at least one controller is further configured to store a result of performing the tuning for the performance and the QoS conformity with the first storage device and a result of performing the tuning for the performance and the QoS conformity with a second storage device, respectively, in independent parameter tables.

8. The storage device of claim 7, wherein the at least one controller is further configured to store information of the first storage device or environment information of the tuning, which is associated with each of the parameter tables, as parameter metadata.

9. The storage device of claim 8, wherein the at least one controller is further configured to:
receive, from a host device, a request indicating transmission of a first parameter table based on the parameter metadata; and
in response to the request, send the first parameter table to the host device.

10. A storage device comprising:
at least one nonvolatile memory device; and
at least one controller configured to control the at least one nonvolatile memory device and to perform a workload based on at least one parameter,
wherein a value of the at least one parameter is set such that:
a first similarity between a first performance measured when the storage device performs the workload and a second performance measured when a second storage device performs the workload is maximized, and
a second similarity between a quality of service (QOS) index of the storage device and a QoS index of the second storage device is maximized, and
wherein, based on the first similarity and the second similarity, the at least one parameter is set individually for each workload of a plurality of workloads.

11. The storage device of claim 10, wherein the at least one nonvolatile memory device is configured to store a plurality of parameter tables, at which different values are recorded with regard to the at least one parameter, in one region of the at least one nonvolatile memory device, and
wherein the at least one controller is configured to:
in response to a command of a host device, activate one parameter table among the plurality of parameter tables; and
perform the workload based on the value of the at least one parameter.

12. The storage device of claim 10, wherein the at least one parameter comprises a plurality of parameters,
wherein the at least one nonvolatile memory device is configured to store a parameter table, at which values of the plurality of parameters maximizing the first similarity and the second similarity associated with the workload are recorded, in one region of the at least one nonvolatile memory device, and
wherein, in response to a tuning command of a host device, the parameter table is generated by a machine learning-tuning.

13. An operating method of a storage device, the operating method comprising:
receiving a tuning request from a host device;
receiving, from the host device, at least one of a target performance specification and a target QoS specification;
receiving a workload from the host device;
controlling a nonvolatile memory to perform the workload based on a parameter and changing a value of the parameter;
monitoring a performance and a Quality-of-Service (QOS) of the workload for each of the changed value of the parameter; and
determining the value of the parameter for the workload based on the performance and the QoS of the workload,
wherein the determining of the value of the parameter includes:
determining the value of the parameter such that the performance and a QoS conformity with a first storage device associated with the workload is maximized; and
individually determining the value of the parameter for each workload of a plurality of workloads that are different kinds.

14. The method of claim 13, wherein the determining of the value of the parameter further includes:
receiving, from the host device, a learning log generated through a tuning performed in a second storage device based on machine learning; and
performing a machine learning-based tuning by using the learning log for improvement of the performance and the QoS conformity with the first storage device.

15. The method of claim 13, wherein the determining of the value of the parameter further includes:
receiving, from the host device, a learning log generated through a tuning performed in a second storage device based on machine learning; and
determining the value of the parameter to be used in the tuning based on a value of performing performance and at least one parameter included in the learning log.

16. The method of claim 13, wherein the determining of the value of the parameter further includes:
receiving, from the host device, a first parameter table for the performance and the QoS conformity with the first storage device; and
performing the tuning by determining the value of the parameter based on the first parameter table.

17. An operating method of a storage device, the operating method comprising:
receiving, from a host device, a transmission request for a parameter metadata;
in response to the request, sending the parameter metadata to the host device;
receiving a request indicating an activation of a parameter table included in the parameter metadata, wherein the parameter table is associated with one of pieces of information of the parameter table;
activating the parameter table designated by the host device;
detecting a workload assigned by the host device; and
based on the detected workload that is associated with the parameter table, performing the detected workload based on the parameter table.

18. The operating method of claim 17, further comprising:
receiving a transmission request for a parameter table included in the parameter metadata; and
sending the parameter table to the host device.

19. An operating method of a storage device, the operating method comprising:
receiving, from a host device, a request indicating a tuning for a performance and a Quality-of-Service (QOS (conformity with a first storage device;
sending a response to the tuning to the host device;
receiving a parameter table from the host device; and
activating the parameter table.

20. The operating method of claim 19, further comprising:
receiving a workload from the host device; and
performing the workload based on the parameter table.
